(19) United States
(12) Patent Application Publication
(10) Pub. No.: US 2026/0111891 A1
(43) Pub. Date: Apr. 23, 2026

(54) METHOD AND SYSTEM FOR TRACING TRANSACTION LIFECYCLES

(71) Applicant: JPMorgan Chase Bank, N.A., New York, NY (US)

(72) Inventors: Shailesh SINGH, Frisco, TX (US); Igor VASILCOVSKY, Hohokus, NJ (US); Mohit KHANDEKAR, Tampa, FL (US); Nicholas P STUMPOS, Chicago, IL (US); Aravind SUNDARAJ, Frisco, TX (US); Taylor HAVERKAMP, Mountain Lakes, NJ (US); Amalesh PRADHAN, Plano, TX (US)

(73) Assignee: JPMorgan Chase Bank, N.A., New York, NY (US)

(21) Appl. No.: 18/920,139

(22) Filed: Oct. 18, 2024

(51) Int. Cl. G06Q 20/40

(52) U.S. Cl. CPC G06Q 20/401

(57) ABSTRACT

A method and a system for ensuring reliability of a customer journey with a platform are provided. The method includes: receiving transaction data associated with at least one event; generating, via a domain event library, a trace object for tracing information associated with the transaction data, wherein the trace object includes a first field for an event identification (ID) and a second field for a parent ID; analyzing the trace object to determine whether there is at least one potential issue relating to the transaction data; and when a determination is made that there is at least one potential issue, flagging the transaction data.

### BACKGROUND

### 1. Field of the Disclosure

This technology generally relates to methods and systems for tracing transactions, and more particularly to methods and systems for generating a trace object to be associated with transaction data for providing an overview of the transaction lifecycle.

### 2. Background Information

In financial institutions manual investigations and cleanups of individual transactions are performed in order to reconcile account and transaction data. This manual process results in hours of extra effort each week and is largely unsustainable due to several types of transaction events and errors, including: 1) Partial Payouts—when a transaction is split across payouts, it may be journaled on one day but not funded to the merchant until the next day. 2) Deferred/Negative Payouts—similar to partial payouts. Transactions may be journaled on one day but not settled until a net positive payout is processed. 3) Deduplication (de-dup) Events—identifying duplicate events requires a significant amount of time and processing power to do accurately, due to the size of the natural keys (i.e., data attributes) used on inter-events. 4) Records out of Order—payments lifecycle processing can become blocked when consumers receive inter-events out of normal order, and there is no natural key available to properly trace the events. 5) Erroneous Tracing—when natural keys are not available, erroneous tracing can occur due to approximate methods of linking events together in a payment lifecycle.

Currently, business faces the following challenges: 1) users cannot easily link events together throughout a payments lifecycle; 2) users do not have the ability to confirm whether all necessary events for a payment have been published from a reconciliation reporting/audit standpoint; and 3) users cannot identify whether duplicate events are published upstream, which may result in erroneous reporting due to double counting.

Additionally, disparate de-dup keys across lifecycle use cases means that there are a lot of different de-dup criteria. The reuse of events increases the complexity and performance to complete simple de-duping. Several issues involving finance reconciliation counts include: 1) Wide-reaching Impact on Customers: when critical financial applications experience downtime, the impact can be massive. In a past scenario, millions of customers were affected by the downtime of a critical financial application. This widespread impact not only affects customer satisfaction but also erodes trust in the organization's ability to provide reliable services. 2) Extended Downtime: the critical financial application in question was down for more than 15 hours. Such extended downtime has severe implications, including financial losses, regulatory repercussions, and damage to the organization's reputation. For financial applications, even minor downtimes can have cascading effects on transactions, customer trust, and overall market standing. 3) Prolonged Detection and Mitigation: the mean time to detect (MTTD) and the mean time to mitigate (MTTM) these issues were both more than 16 hours. This extended response time poses a significant challenge for businesses, as prolonged detection and mitigation times lead to extended periods of service unavailability, compounding the negative impacts on customers and business operations.

Accordingly, there is a need for generating a trace object to be associated with transaction data for providing an overview of the transaction lifecycle.

### SUMMARY

The present disclosure, through one or more of its various aspects, embodiments, and/or specific features or sub-components, provides, inter alia, various systems, servers, devices, methods, media, programs, and platforms for generating a trace object to be associated with transaction data for providing an overview of the transaction lifecycle.

According to an aspect of the present disclosure, a method for tracing transactions is provided. The method may be implemented by at least one processor. The method may include: receiving, by the at least one processor, transaction data associated with at least one event; generating, by the at least one processor via a domain event library, a trace object for tracing information associated with the transaction data, wherein the trace object includes a first field for an event identification (ID) and a second field for a parent ID; analyzing, by the at least one processor, the trace object to determine whether there is at least one potential issue relating to the transaction data; and when a determination is made that there is at least one potential issue, flagging, by the at least one processor, the transaction data.

The event ID may be a unique identifier and may be associated with the at least one event.

The event ID may have a first alpha-numeric value, and the first alpha-numeric value may include a combination of at least one from among a transaction ID, a payment request ID, an event type ID, and the parent ID.

The parent ID may be associated with a parent event of the at least one event.

The analyzing of the trace object may relate to at least one from among a partial payout event, a deferred payout event, a negative payout event, a duplicate event, a record of events that is out of order, and a tracing error.

The trace object may further include a third field having a second value, and the second value may include a listing of each event that occurs subsequently that relate to an occurrence of the at least one event.

The method may further include displaying, by the at least one processor via a graphical user interface (GUI), a chronology of events that occurs subsequently that relate to an occurrence of the at least one event.

The method may further include: receiving from a user, by the at least one processor via the GUI, an input that includes a transaction ID; determining, by the at least one processor, whether the input is invalid; when the input is invalid, generating, by the at least one processor, an alert and transmitting the alert to the user; when the input is not invalid, generating, by the at least one processor and based on the transaction ID, a request to retrieve event data from the transaction data; retrieving, by the at least one processor, the requested event data; and displaying, by the at least one processor via the GUI, the requested event data.

Each event of the at least one event may be a financial transaction that is recorded on a customer banking platform.

According to another aspect of the present disclosure, a computing apparatus for tracing transactions is provided. The computing apparatus may include a processor; a memory; and a communication interface coupled to each of the processor, and the memory. The processor may be configured to: receive, via the communication interface, transaction data associated with at least one event; generate, via a domain event library, a trace object for tracing information associated with the transaction data, wherein the trace object includes a first field for an event identification (ID) and a second field for a parent ID; analyze the trace object to determine whether there is at least one potential issue relating to the transaction data; and when a determination is made that there is at least one potential issue, flag the transaction data.

The event ID may be a unique identifier and may be associated with the at least one event.

The event ID may have a first alpha-numeric value, and the first alpha-numeric value may include a combination of at least one from among a transaction ID, a payment request ID, an event type ID, and the parent ID.

The parent ID may be associated with a parent event of the at least one event.

The analysis of the trace object may relate to at least one from among a partial payout event, a deferred payout event, a negative payout event, a duplicate event, a record of events that is out of order, and a tracing error.

The trace object may further include a third field having a second value, and the second value may include a listing of each event that occurs subsequently that relate to an occurrence of the at least one event.

The processor may be further configured to display, via a graphical user interface (GUI), a chronology of events that occurs subsequently that relate to an occurrence of the at least one event.

The processor may be further configured to: receive from a user, via the GUI, an input that includes a transaction ID; determine whether the input is invalid; when the input is invalid, generate an alert and transmit the alert to the user; when the input is not invalid, generate, based on the transaction ID, a request to retrieve event data from the transaction data; retrieve the requested event data; and display, via the GUI, the requested event data.

Each event of the at least one event may be a financial transaction that is recorded on a customer banking platform.

According to yet another aspect of the present disclosure, a non-transitory computer readable storage medium storing instructions for tracing transactions is provided. The storage medium includes executable code which, when executed by a processor, may cause the processor to: receive transaction data associated with at least one event; generate, via a domain event library, a trace object for tracing information associated with the transaction data, wherein the trace object includes a first field for an event identification (ID) and a second field for a parent ID; analyze the trace object to determine whether there is at least one potential issue relating to the transaction data; and when a determination is made that there is at least one potential issue, flag the transaction data.

The event ID may be a unique identifier and may be associated with the at least one event.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for generating a trace object to be associated with transaction data for providing an overview of the transaction lifecycle, according to an embodiment.

FIG. 2 illustrates a diagram of a network environment for generating a trace object to be associated with transaction data for providing an overview of the transaction lifecycle, according to an embodiment.

FIG. 3 illustrates a system diagram of a system for generating a trace object to be associated with transaction data for providing an overview of the transaction lifecycle, according to an embodiment.

FIG. 4 illustrates a process diagram of a process for generating a trace object to be associated with transaction data for providing an overview of the transaction lifecycle, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein generates a trace object that can be used to illustrate each transaction and event throughout a transaction lifecycle. Particularly, the system receives data that relates to a plurality of transaction events. For each separate transaction, the system creates a trace object with multiple fields that contain specific identifiers that allow the users to recreate or trace each step of that transactions lifecycle. The system may also use this trace object to analyze the transaction data and flag any discrepancies, issues, or errors that are recognized by the system. By generating and using this trace object, the system and/or a user can see where a particular transaction event came from and what happened before this particular transaction event. Additionally, the whole story of a specific transaction may be joined together so that it is easily analyzed and identifiable. This system and method solves each of the major problems businesses currently face involving the accounting and correcting of transactional data. For example, the disclosed system and method may quickly and easily link events together throughout a payments lifecycle. It may also confirm whether all necessary events for a payment have been published from a reconciliation/reporting/audit standpoint. And the system and method may identify whether duplicate events are published upstream and reduce erroneous reporting due to double counting. Moreover, when the trace object is embedded in every transaction event, the system and method may provide an absolute trace view of the transaction lifecycles. Also, events data may be stored with all details to provide different views/capabilities to the business. For example, the system and method may: provide a chronology view of transaction events for a given transaction ID; allow transactions to be viewed where all necessary events for a payment have not been published (i.e., transactions where their current lifecycle state is past their configured service level agreement (SLA)); and identify duplicate events published upstream based on an event ID.

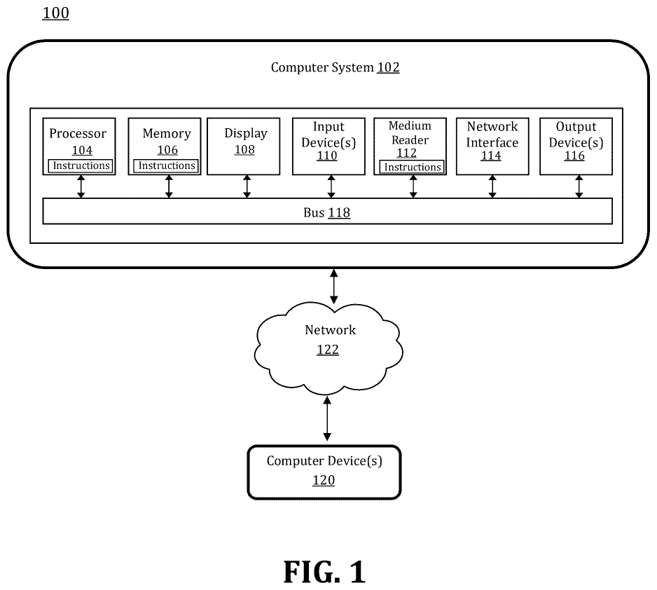

FIG. 1 is a system 100 for generating a trace object to be associated with transaction data for providing an overview of the transaction lifecycle, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the transaction tracing module implemented by the system 100 may allow for generating a trace object to be associated with transaction data for providing an overview of the transaction lifecycle. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

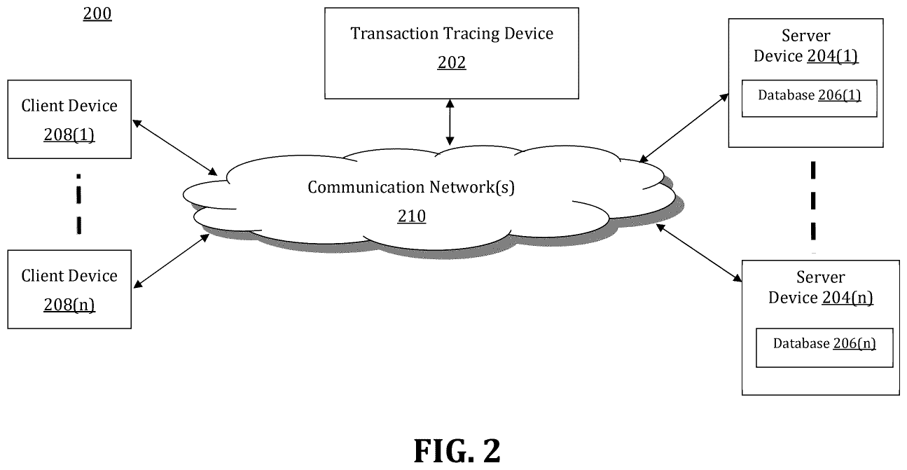

Referring to FIG. 2, a schematic of a network environment 200 for generating a trace object to be associated with transaction data for providing an overview of the transaction lifecycle is illustrated.

In some embodiments, the above-described problems associated with conventional tools may be overcome by implementing a transaction tracing device 202 as illustrated in FIG. 2 that may be configured for generating a trace object to be associated with transaction data for providing an overview of the transaction lifecycle, but the disclosure is not limited thereto.

The transaction tracing device 202 may include one or more computer systems 102, as described with respect to FIG. 1, which in aggregate provide the necessary functions.

The transaction tracing device 202 may store one or more applications that can include executable instructions that, when executed by the transaction tracing device 202, cause the transaction tracing device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the transaction tracing device 202 itself, may be located in virtual server(s) running in a cloud-based computing environment rather than being tied to one or more specific physical network computing devices. Also, the application(s) may be running in one or more virtual machines (VMs) executing on the transaction tracing device 202. Additionally, in one or more embodiments of this technology, virtual machine(s) running on the transaction tracing device 202 may be managed or supervised by a hypervisor.

In the network environment 200 of FIG. 2, the transaction tracing device 202 may be coupled to a plurality of server devices 204(1)-204(n) that hosts a plurality of databases 206(1)-206(n), and also to a plurality of client devices 208(1)-208(n) via communication network(s) 210. A communication interface of the transaction tracing device 202, such as the network interface 114 of the computer system 102 of FIG. 1, operatively couples and communicates between the transaction tracing device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the transaction tracing device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The transaction tracing device 202 may be a standalone device or integrated with one or more other devices or apparatuses, such as one or more of the server devices 204(1)-204(n), for example. In one example, the transaction tracing device 202 may be hosted by one of the server devices 204(1)-204(n), and other arrangements are also possible. Moreover, one or more of the devices of the transaction tracing device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the authentication device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the transaction tracing device 202 that may generate a trace object to be associated with a transaction data for providing an overview of the transaction lifecycle, but the disclosure is not limited thereto.

The client devices 208(1)-208(n) may run interface applications, such as standard web browsers or standalone client applications, which may provide an interface to communicate with the transaction tracing device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the transaction tracing device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the transaction tracing device 202, the server devices 204(1)-204(n), or the client devices 208(1)-208(n), for example, may be configured to operate as virtual instances on the same physical machine. For example, one or more of the transaction tracing devices 202, the server devices 204(1)-204(n), or the client devices 208(1)-208(n) may operate on the same physical device rather than as separate devices communicating through communication network(s) 210. Additionally, there may be more or fewer transaction tracing devices 202, server devices 204(1)-204(n), or client devices 208(1)-208(n) than illustrated in FIG. 2. In some embodiments, the transaction tracing device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

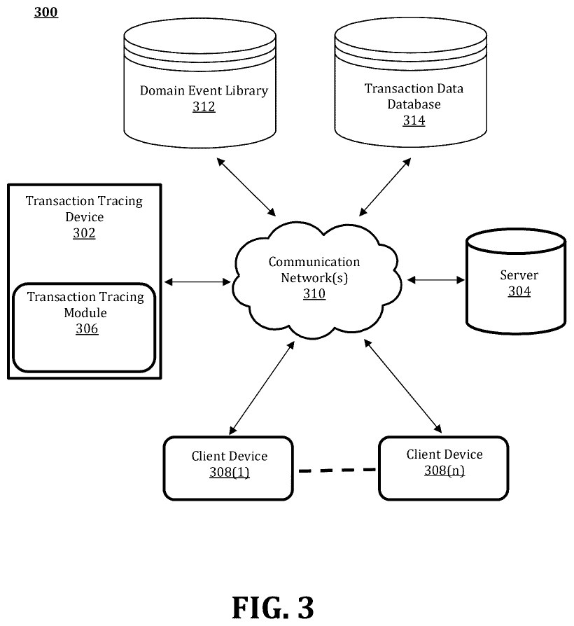

FIG. 3 illustrates a system diagram for generating a trace object to be associated with transaction data for providing an overview of the transaction lifecycle, in accordance with an embodiment.

As illustrated in FIG. 3, the system 300 may include a transaction tracing device 302 within which a transaction tracing module 306 is embedded, a server 304, a domain event library 312, a transaction data database 314, a plurality of client devices 308(1) . . . 308(n), and a communication network 310.

In some embodiments, the transaction tracing device 302 including the transaction tracing module 306 may be connected to the server 304, the domain event library 312, and the transaction data database 314 via the communication network 310. The transaction tracing device 302 may also be connected to the plurality of client devices 308(1) . . . 308(n) via the communication network 310, but the disclosure is not limited thereto. The domain event library 312 and the transaction data database 314 may include one or more libraries or databases.

In an embodiment, the transaction tracing device 302 is described and shown in FIG. 3 as including the transaction tracing module 306, although it may include other rules, policies, modules, databases, or applications, for example. In some embodiments, the domain event library 312 and the transaction data database 314 may be configured to store ready to use modules written for each API for all environments. Although only one database and one library are illustrated in FIG. 3, the disclosure is not limited thereto. Any number of desired databases and/or libraries may be utilized for use in the disclosed invention herein. The domain event library 312 and the transaction data database 314 may be a mainframe database, a log database that may produce programming for searching, monitoring, and analyzing machine-generated data via a web interface, but the disclosure is not limited thereto. In addition, the domain event library 312 and the transaction data database 314 may store a plurality of data sets and predictive models for tracing transaction events.

In some embodiments, the transaction tracing module 306 may be configured to receive real-time feed of data from the plurality of client devices 308(1) . . . 308(n) and secondary sources via the communication network 310.

The transaction tracing module 306 may be configured to: receive transaction data associated with at least one event; generate, via a domain event library, a trace object for tracing information associated with the transaction data, wherein the trace object includes a first field for an event identification (ID) and a second field for a parent ID; analyze the trace object to determine whether there is at least one potential issue relating to the transaction data; and when a determination is made that there is at least one potential issue, flag the transaction data.

The plurality of client devices 308(1) . . . 308(n) are illustrated as being in communication with the transaction tracing device 302. In this regard, the plurality of client devices 308(1) . . . 308(n) may be “clients” (e.g., customers) of the transaction tracing device 302 and are described herein as such. Nevertheless, it is to be known and understood that the plurality of client devices 308(1) . . . 308(n) need not necessarily be “clients” of the transaction tracing device 302, or any entity described in association therewith herein. Any additional or alternative relationship may exist between either or both plurality of client devices 308(1) . . . 308(n) and the transaction tracing device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the transaction tracing device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The transaction tracing device 302 may be the same or similar to the transaction tracing device 202 as described with respect to FIG. 2, including any features or combination of features described with respect thereto.

Upon being started, the transaction tracing device 302 executes a process for generating a trace object to be associated with transaction data for providing an overview of the transaction lifecycle.

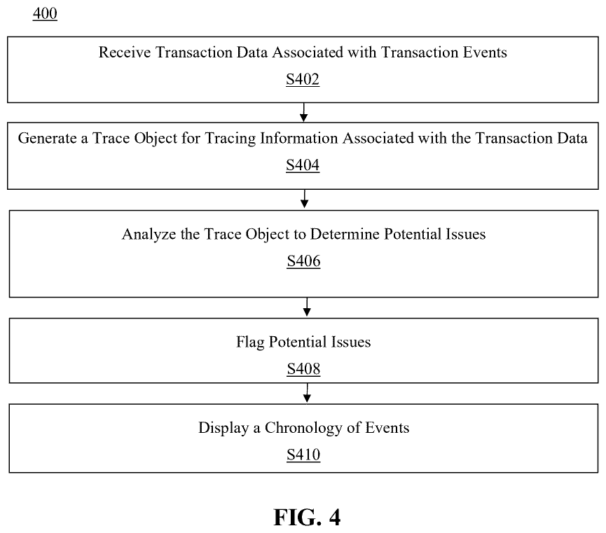

FIG. 4 illustrates a process 400 for generating a trace object to be associated with transaction data for providing an overview of the transaction lifecycle, according to an embodiment.

In process 400 of FIG. 4, at step S402, the transaction tracing device 302 may be configured to receive transaction data that is associated with at least one event. In some embodiments, the events may be financial transactions that are recorded on a customer banking platform. For example, the events may correspond to payment transactions associated with a customer's banking card.

At step S404, the transaction tracing device 302 may be configured to generate a trace object for tracing information associated with the transaction data. The trace object may include a first field for an event identification (ID) and a second field for a parent ID. In some embodiments, the trace object may further include a third field or fingerprint field. The fingerprint field may help simplify the tracing of transactions, minimize post processing, and guard against possible data loss, by providing a listing of the entire chain of events created as part of the given transaction/event. Each field may have corresponding values that are a series alpha-numeric characters that create an identifier. The event ID may have an alpha-numeric value that includes a combination of at least one from among a transaction ID, a payment request ID, an event type ID, and the parent ID. For example, the event ID may correspond to a unique ID generated using: hash (transaction ID)+payment Request ID+event Type ID+ parent ID). The parent ID may be associated with a parent event of the at least one event and may be an alpha-numeric value that is associated with and/or common between each event or transaction within the family of transactions. In an embodiment, the parent ID for previous events may be transmitted to and included in the trace object for subsequent child events. For example, the parent ID may correspond to an ID of a parent event and that may be set to “Null” when a Payment is approved. The fingerprint field may relate to a unique identifier of alpha-numeric values that includes a listing of each event that occurs subsequently that relate to an occurrence of the at least one event. The trace object may be generated via the domain event library 312. The domain event library may generate a plurality of identifiers that are used to create the trace objects. The identifiers from the domain event library may be based on at least one from the type of event or transaction, the user or account for which the event occurs, and the organization or business unit responsible for handling or processing that type of event. The domain event library 312 may provide at least one identifier as part of the trace object for tracing the event. The at least one identifier may correspond to at least one from among the event ID value, the parent ID value, and the fingerprint field value. Table 1 below illustrates an example trace object including an event ID field, a Parent ID field, and fingerprint field, as well corresponding example values for each respective field.

TABLE 1
Example Trace Object

| Field | Value |
|---|---|
| Event ID | fd61a03a |
| Parent ID | 60303aed |
| Fingerprint | [ {type: Payment Approved, id: a4e624d6}, |
| | {type: Payment Closed, id a140c0c1}, |
| | {type: Configure, Price, Quote (CPQ), id: 60303aed} ] |

At step S406, the transaction tracing device 302 may be configured to analyze the trace object to determine whether there is a potential issue relating to the transaction data. In an embodiment, the transaction tracing device 302 may be configured to analyze the trace object with regard to at least one from among a partial payout event, a deferred payout event, a negative payout event, a duplicate event, a record of events that is out of order, and a tracing error. For example, the transaction tracing device 302 may be configured to identify when duplicate events have been published based on the same event ID.

At step S408, the transaction tracing device 302 may be configured to flag the transaction data for correction when a potential issue is identified. For example, the transaction tracing device 302 may be configured to flag the transaction data when a duplicate event is identified so that the duplicate event may be deleted. In an embodiment, the transaction tracing device 302 may be configured to automatically correct the identified issue. For example, the transaction tracing device 302 may be configured to delete duplicate events that are identified and flagged within the transaction data.

Then, at step S410, the transaction tracing device 302 may be configured to display a chronology of event data via a GUI. The tracing device 302 may display a chronology so that a user may view each event for a given transaction ID. For example, according to an embodiment, when the trace object is embedded in every event transaction, the tracing device 302 may display an absolute trace view of the transaction lifecycle. In some embodiments, event data may be stored and displayable with all the details so that a user may view a variety of different transaction lifecycle data. The tracing device 302 may also display transactions where all necessary events for a payment have not been published (i.e., transactions where their current lifecycle state is past their configured SLA).

In some embodiments, the transaction tracing device 302 may be configured to receive, via the GUI, an input from a user that includes a transaction ID. The transaction tracing device 302 may first analyze the input and determine whether the input including the transaction ID is valid or invalid. For example, the request may be required to include a transaction ID, a lifecycle, and an event type code. If the request does not include these features, then the request may be invalid. If the input is invalid, the transaction tracing device 302 may be configured to generate and transmit an alert to the user notifying them that the input is invalid. For example, the transaction tracing device 302 may be configured to generate the following alerts: 1) Transaction ID is null—transaction ID is missing in argument. Transaction Identifier: null; 2) No Lifecycle—invalid lifecycle passed in argument. Lifecycle: null; and 3) Event Type is missing—event type is missing in argument. Event Type Code. If the input is valid, the transaction tracing device 302 may be configured to generate a request to retrieve event data from the transaction data, based on the transaction ID. The transaction tracing device 302 may be configured to then retrieve and display the requested event data.

Accordingly, with this technology, an optimized process for generating a trace object to be associated with transaction data for providing an overview of the transaction lifecycle is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for tracing transactions, the method being implemented by at least one processor, the method comprising:
receiving, by the at least one processor, transaction data associated with at least one event;
generating, by the at least one processor via a domain event library, a trace object that traces information associated with the transaction data by listing a chain of events created as part of the at least one event, wherein the trace object includes a first field for an event identification (ID) and a second field for a parent ID, wherein the parent ID is an identifier associated with a preceding related event, and wherein the parent ID is consistent across a family of related events;
analyzing, by the at least one processor, each field of the trace object to determine whether there is at least one potential issue relating to the transaction data;
determining, by the at least one processor, that there is at least one issue associated with a subset of the transaction data, based on a determination that at least one field of the trace object is invalid;
flagging, by the at least one processor and based on a result of the determining that there is at least one issue, the subset of the transaction data by identifying and marking the subset of the transaction data as having the at least one issue; and
automatically amending, by the at least one processor, the flagged subset of the transaction data to correct the at least one issue.

2. The method of claim 1, wherein the event ID is a unique identifier and is associated with the at least one event.

3. The method of claim 2, wherein the event ID has a first alpha-numeric value, and wherein the first alpha-numeric value comprises a combination of at least one from among a transaction ID, a payment request ID, an event type ID, and the parent ID.

4. (canceled)

5. The method of claim 1, wherein the analyzing of the trace object relates to at least one from among a partial payout event, a deferred payout event, a negative payout event, a duplicate event, a record of events that is out of order, and a tracing error.

6. The method of claim 1, wherein the trace object further includes a third field having a second value, and wherein the second value includes a listing of each event from the chain of events that are related to the at least one event and that precede the at least one event.

7. The method of claim 1, further comprising:
displaying, by the at least one processor via a graphical user interface (GUI), a chronology of events from the chain of events that are related to the at least one event and that precede the at least one event,
wherein the GUI displays an absolute trace view associated with a transaction lifecycle of the at least one event such that a variety of different transaction lifecycle data is viewable in a single display.

8. The method of claim 7, further comprising:
receiving from a user, by the at least one processor via the GUI, an input that includes a transaction ID;
determining, by the at least one processor, whether the input is invalid;
when the input is invalid, generating, by the at least one processor, an alert and transmitting the alert to the user;
when the input is not invalid, generating, by the at least one processor and based on the transaction ID, a request to retrieve event data from the transaction data;
retrieving, by the at least one processor, the requested event data; and
displaying, by the at least one processor via the GUI, the requested event data.

9. The method of claim 1, wherein each event of the at least one event is a financial transaction that is recorded on a customer banking platform.

10. A computing apparatus for tracing transactions, the computing apparatus comprising:
a processor;
a memory; and
a communication interface coupled to each of the processor and the memory,
wherein the processor is configured to:
receive, via the communication interface, transaction data associated with at least one event;
generate, via a domain event library, a trace object that traces information associated with the transaction data by listing a chain of events created as part of the at least one event, wherein the trace object includes a first field for an event identification (ID) and a second field for a parent ID, wherein the parent ID is an identifier associated with a preceding related event, and wherein the parent ID is consistent across a family of related events;
analyze each field of the trace object to determine whether there is at least one potential issue relating to the transaction data;
determine that there is at least one issue associated with a subset of the transaction data, based on a determination that at least one field of the trace object is invalid;
flag, based on a result of the determining that there is at least one issue, the subset of the transaction data by identifying and marking the subset of the transaction data as having the at least one issue; and
automatically amend the flagged subset of the transaction data to correct the at least one issue.

11. The computing apparatus of claim 10, wherein the event ID is a unique identifier and is associated with the at least one event.

12. The computing apparatus of claim 11, wherein the event ID has a first alpha-numeric value, and wherein the first alpha-numeric value comprises a combination of at least one from among a transaction ID, a payment request ID, an event type ID, and the parent ID.

13. (canceled)

14. The computing apparatus of claim 10, wherein the analysis of the trace object relates to at least one from among a partial payout event, a deferred payout event, a negative payout event, a duplicate event, a record of events that is out of order, and a tracing error.

15. The computing apparatus of claim 10, wherein the trace object further includes a third field having a second value, and wherein the second value includes a listing of each event from the chain of events that are related to the at least one event and that precede the at least one event.

16. The computing apparatus of claim 10, wherein the processor is further configured to:
display, via a graphical user interface (GUI), a chronology of events from the chain of events that are related to the at least one event and that precede the at least one event.

17. The computing apparatus of claim 10, wherein the processor is further configured to:
receive from a user, via the GUI, an input that includes a transaction ID;
determine whether the input is invalid;
when the input is invalid, generate an alert and transmit the alert to the user;
when the input is not invalid, generate, based on the transaction ID, a request to retrieve event data from the transaction data;
retrieve the requested event data; and
display, via the GUI, the requested event data.

18. The computing apparatus of claim 10, wherein each event of the at least one event is a financial transaction that is recorded on a customer banking platform.

19. A non-transitory computer readable storage medium storing instructions for tracing transactions, the storage medium comprising executable code which, when executed by a processor, causes the processor to:
receive transaction data associated with at least one event;
generate, via a domain event library, a trace object that traces information associated with the transaction data by listing a chain of events created as part of the at least one event, wherein the trace object includes a first field for an event identification (ID) and a second field for a parent ID, wherein the parent ID is an identifier associated with a preceding related event, and wherein the parent ID is consistent across a family of related events;
analyze each field of the trace object to determine whether there is at least one potential issue relating to the transaction data;
determine that there is at least one issue associated with a subset of the transaction data, based on a determination that at least one field of the trace object is invalid;
flag, based on a result of the determining that there is at least one issue, the subset of the transaction data by identifying and marking the subset of the transaction data as having the at least one issue; and
automatically amend the flagged subset of the transaction data to correct the at least one issue.

20. The storage medium as claimed in claim 19, wherein the event ID is a unique identifier and is associated with the at least one event.
